(19) United States
(12) Patent Application Publication
(10) Pub. No.: US 2012/0327310 A1
(43) Pub. Date: Dec. 27, 2012

(54) OBJECT DETECTING DEVICE AND INFORMATION ACQUIRING DEVICE

(75) Inventors: Takaaki MORIMOTO, Kakogawa-shi (JP); Katsumi Umeda, Niwa-gun (JP)

(73) Assignee: Sanyo Electric Co., Ltd., Moriguchi-shi (JP)

(21) Appl. No.: 13/596,991

(22) Filed: Aug. 28, 2012

Related U.S. Application Data
(63) Continuation of application No. PCT/JP2011/062663, filed on Jun. 2, 2011.

(30) Foreign Application Priority Data
Aug. 25, 2010 (JP) 2010-188925
May 25, 2011 (JP) 2011-116701

(51) Int. Cl. H04N 5/44

(52) U.S. Cl. 348/734; 348/E05.096

(57) ABSTRACT

An information acquiring device has a light source which emits light of a predetermined wavelength band; a projection optical system which projects the light emitted from the light source toward the target area with a predetermined dot pattern; a light receiving element which receives reflected light reflected on the target area for outputting a signal; a storage which stores a reference template in which a plurality of reference segment areas are set on a reference pattern of the light to be received by the light receiving element; and an updating section which updates the reference template. In this arrangement, the updating section updates the reference template, based on a displacement to be detected when a referenced segment area set in the reference template is actually measured.

This application claims priority under 35 U.S.C. Section 119 of Japanese Patent Application No. 2010-188925 filed Aug. 25, 2010, entitled “OBJECT DETECTING DEVICE AND INFORMATION ACQUIRING DEVICE” and Japanese Patent Application No. 2011-116701 filed May 25, 2011, entitled “OBJECT DETECTING DEVICE AND INFORMATION ACQUIRING DEVICE”. The disclosures of the above applications are incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to scan a target area with laser light having a predetermined dot pattern is operable to receive a dot pattern reflected on the target area on an image sensor for detecting a distance to each portion of an object to be detected, based on a light receiving position of the dot pattern on the image sensor, using a triangulation method (see e.g. pp. 1279-1280, the 19th Annual Conference Proceedings (Sep. 18-20, 2001) by the Robotics Society of Japan).

In the above method, for instance, laser light having a dot pattern is emitted in a state that a reflection plane is disposed at a position away from an irradiation portion of laser light by a certain distance, and the dot pattern of laser light irradiated onto the image sensor is retained as a template. Then, a matching operation is performed between a dot pattern of laser light irradiated onto the image sensor at the time of actual measurement, and the dot pattern retained in the template for detecting to which position on the dot pattern at the time of actual measurement, a segment area set on the dot pattern of the template has moved. The distance to each portion, in the target area, corresponding to each segment area, is calculated, based on the moving amount.

In the object detecting device thus constructed, a diffractive optical element for generating laser light having a dot pattern is used. The dot pattern of laser light has dependency on e.g. the shape or the position of the diffractive optical element, and the wavelength of laser light. However, these factors are likely to change depending on a temperature, and may change as time elapses. In particular, in the case where the diffractive optical element is made of a resin material, the characteristic of the diffractive optical element is likely to change depending on a temperature, and the dot pattern is also likely to change, as the characteristic of the diffractive optical element changes. If the dot pattern changes as described above, the dot pattern retained as the template is no longer appropriate, and it is impossible to perform a matching operation between a dot pattern at the time of actual measurement and the dot pattern retained in the template. As a result, detection precision of a distance to the object to be detected may be lowered.

### SUMMARY OF THE INVENTION

A first aspect of the invention is directed to an information acquiring device for acquiring information on a target area using light. The information acquiring device according to the first aspect includes a light source which emits light of a predetermined wavelength band; a projection optical system which projects the light emitted from the light source toward the target area with a predetermined dot pattern; a light receiving element which receives reflected light reflected on the target area for outputting a signal; a storage which stores a reference template in which a plurality of reference segment areas are set on a reference pattern of the light to be received by the light receiving element; and an updating section which updates the reference template. In this arrangement, the updating section updates the reference template, based on a displacement of a referenced segment area set in the reference template at the time of actual measurement.

A second aspect of the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIGS. 4A and 4B are diagrams for describing a reference template setting method in the embodiment.

FIGS. 5A through 5C are diagrams for describing a distance detecting method in the embodiment.

FIGS. 6A and 6B are diagrams for describing a state as to how a distance detection error occurs in the embodiment.

FIGS. 7A and 7B are flowcharts showing a template updating processing in the embodiment.

FIGS. 8A and 8B are diagrams showing a template updating method in the embodiment.

FIGS. 9A through 9D are diagrams showing examples, in which a template is updated in the embodiment.

FIGS. 10A through 10D are diagrams showing examples, in which a template is updated in the embodiment.

FIGS. 11A through 11D are diagrams showing modification examples of the template updating method in the embodiment.

FIGS. 12A through 12D are diagrams showing modification examples of the template updating method in the embodiment.

FIGS. 13A through 13D are diagrams showing other referenced segment area setting methods in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings. The embodiment is an example, wherein the invention is applied to an information acquiring device which is configured to irradiate a target area with laser light having a predetermined dot pattern.

In the embodiment, a laser light source 111 corresponds to a “light source” in the claims. A projection optical system 11 (a collimator lens 112, an aperture 113, a DOE 114) correspond to a “projection optical system” in the claims. A CMOS image sensor 124 corresponds to a “light receiving element” in the claims. A memory 25 corresponds to a “storage” in the claims. The description regarding the correspondence between the claims and the embodiment is merely an example, and the claims are not limited by the description of the embodiment.

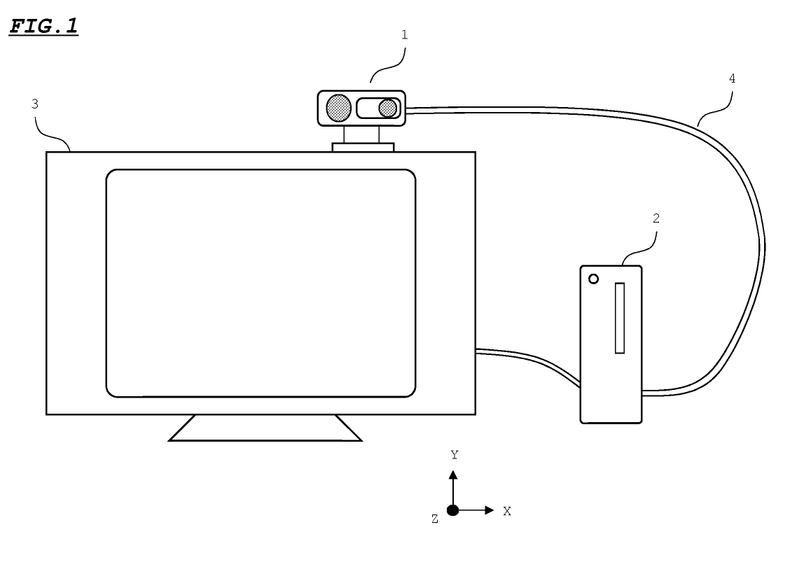

Firstly, a schematic arrangement of an object detecting device according to the first embodiment is described. As shown in FIG. 1, the object detecting device is provided with an information acquiring device 1, and an information processing device 2. ATV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

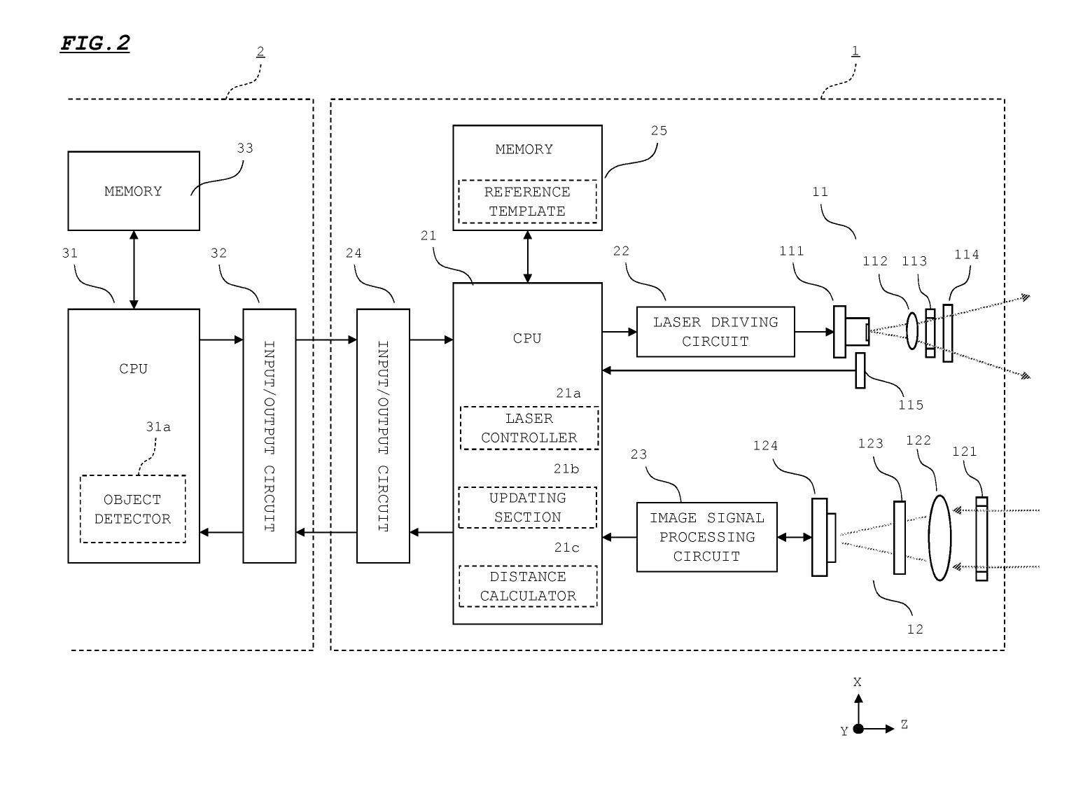

FIG. 2 is a diagram showing an arrangement of the information acquiring device 1 and the information processing device 2.

The information acquiring device 1 is provided with a projection optical system 11 and a light receiving optical system 12, which constitute an optical section. The projection optical system 11 and the light receiving optical system 12 are disposed in the information acquiring device 1 side by side in X-axis direction.

The projection optical system 11 is provided with a laser light source 111, a collimator lens 112, an aperture 113, and a diffractive optical element (DOE) 114. The projection optical system 11 is further provided with a temperature sensor 115. Further, the light receiving optical system 12 is provided with an aperture 121, an imaging lens 122, a filter 123, and a CMOS image sensor 124. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

The laser light source 111 outputs laser light in a narrow wavelength band of or about 830 nm. The collimator lens 112 converts the laser light emitted from the laser light source 111 into parallel light. The aperture 113 adjusts a light flux cross section of laser light into a predetermined shape. The DOE 114 has a diffraction pattern on an incident surface thereof. Laser light entered to the DOE 114 through the aperture 113 is converted into laser light having a dot pattern by a diffractive action of the diffraction pattern, and is irradiated onto a target area. The temperature sensor 115 detects a temperature in the vicinity of the laser light source 111.

Laser light reflected on the target area is entered to the imaging lens 122 through the aperture 121. The aperture 121 converts external light into convergent light in accordance with the F-number of the imaging lens 122. The imaging lens 122 condenses the light entered through the aperture 121 on the CMOS image sensor 124.

The filter 123 is a band-pass filter which transmits light in a wavelength band including the emission wavelength band (in the range of about 830 nm) of the laser light source 111, and blocks light in a visible light wavelength band. The CMOS image sensor 124 receives light condensed on the imaging lens 122, and outputs a signal (electric charge) in accordance with a received light amount to the image signal processing circuit 23 pixel by pixel. In this example, the CMOS image sensor 124 is configured in such a manner that the output speed of signals to be outputted from the CMOS image sensor 124 is set high so that a signal (electric charge) at each pixel can be outputted to the image signal processing circuit 23 with high response from a light receiving timing at each pixel.

The CPU 21 controls the parts of the information acquiring device 1 in accordance with a control program stored in the memory 25. By the control program, the CPU 21 has functions of a laser controller 21a for controlling the laser light source 111, an updating section 21b to be described later, and a three-dimensional distance calculator 21c for generating three-dimensional distance information.

The laser driving circuit 22 drives the laser light source 111 in accordance with a control signal from the CPU 21. The image signal processing circuit 23 controls the CMOS image sensor 124 to successively read signals (electric charges) from the pixels, which have been generated in the CMOS image sensor 124, line by line. Then, the image signal processing circuit 23 outputs the read signals successively to the CPU 21. The CPU 21 calculates a distance from the information acquiring device 1 to each portion of an object to be detected, by a processing to be implemented by the three-dimensional distance calculator 21c, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

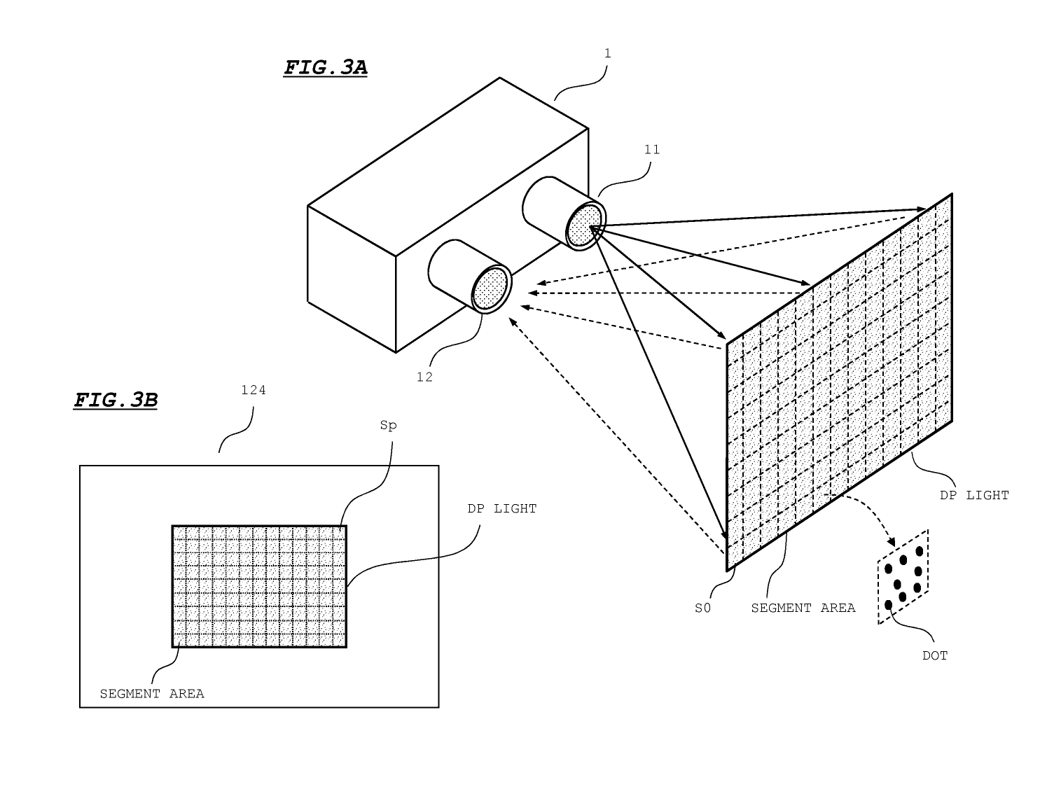

FIG. 3A is a diagram schematically showing an irradiation state of laser light onto a target area. FIG. 3B is a diagram schematically showing a light receiving state of laser light on the CMOS image sensor 124. To simplify the description, FIG. 3B shows a light receiving state in the case where a flat plane (screen) is disposed on a target area.

The projection optical system 11 irradiates a target area with laser light having a dot pattern (hereinafter, the entirety of the laser light having the dot pattern is called as “DPlight”). FIG. 3A shows a light flux area of DP light by a solid-line frame. In the light flux of DP light, dot areas (hereinafter, simply called as “dots”) in which the intensity of laser light is increased by a diffractive action of the DOE 114 locally appear in accordance with the dot pattern by the diffractive action of the DOE 114.

To simplify the description, in FIG. 3A, a light flux of DP light is divided into segment areas arranged in the form of a matrix. Dots locally appear with a unique pattern in each segment area. The dot appearance pattern in a certain segment area differs from the dot appearance patterns in all the other segment areas. With this configuration, each segment area is identifiable from all the other segment areas by a unique dot appearance pattern of the segment area.

When a flat plane (screen) exists in a target area, the segment areas of DP light reflected on the flat plane are distributed in the form of a matrix on the CMOS image sensor 124, as shown in FIG. 3B. For instance, light of a segment area S0 in the target area shown in FIG. 3A is entered to a segment area Sp shown in FIG. 3B, on the CMOS image sensor 124. In FIG. 3B, a light flux area of DP light is also indicated by a solid-line frame, and to simplify the description, a light flux of DP light is divided into segment areas arranged in the form of a matrix in the same manner as shown in FIG. 3A.

The three-dimensional distance calculator 21c is operable to detect a position of each segment area on the CMOS image sensor 124 for detecting a distance to a position of an object to be detected corresponding to the segment area, based on the detected position of the segment area, using a triangulation method. The details of the above detection method is disclosed in e.g. pp. 1279-1280, the 19th Annual Conference Proceedings (Sep. 18-20, 2001) by the Robotics Society of Japan.

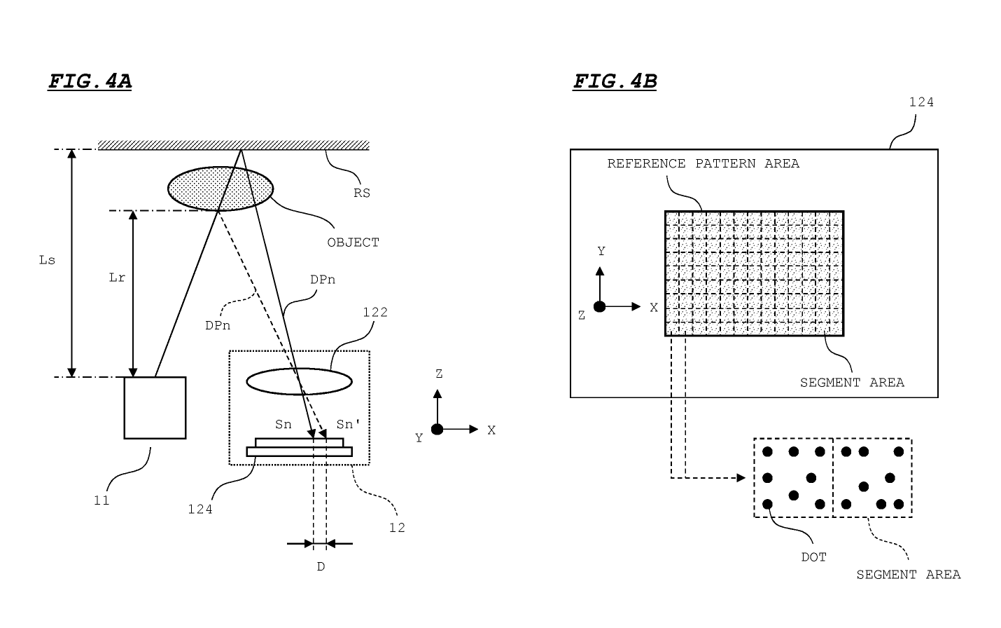

FIGS. 4A, 4B are diagrams schematically showing a reference template generation method for use in the aforementioned distance detection.

As shown in FIG. 4A, at the time of generating a reference template, a reflection plane RS perpendicular to Z-axis direction is disposed at a position away from the projection optical system 11 by a predetermined distance Ls. Then, DP light is emitted from the projection optical system 11 for a predetermined time Te in the above state. The emitted DP light is reflected on the reflection plane RS, and is entered to the CMOS image sensor 124 in the light receiving optical system 12. By performing the above operation, an electrical signal at each pixel is outputted from the CMOS image sensor 124. The value (pixel value) of the electrical signal at each outputted pixel is expanded in the memory 25 shown in FIG. 2.

As shown in FIG. 4B, a reference pattern area for defining an irradiation area of DP light on the CMOS image sensor 124 is set, based on the pixel values expanded in the memory 25. Further, the reference pattern area is divided into segment areas in the form of a matrix. As described above, dots locally appear with a unique pattern in each segment area. Accordingly, each segment area has a different pattern of pixel values. Each one of the segment areas has the same size as all the other segment areas.

The reference template is configured in such a manner that pixel values of the pixels included in each segment area set on the CMOS image sensor 124 are correlated to the segment area.

Specifically, the reference template includes information relating to the position of a reference pattern area on the CMOS image sensor 124, pixel values of all the pixels included in the reference pattern area, and information for use in dividing the reference pattern area into segment areas. The pixel values of all the pixels included in the reference pattern area correspond to a dot pattern of DP light included in the reference pattern area. Further, pixel values of pixels included in each segment area are acquired by dividing a mapping area on pixel values of all the pixels included in the reference pattern area into segment areas. The reference template may retain pixel values of pixels included in each segment area, for each segment area.

The reference template thus configured is stored in the memory 25 shown in FIG. 2 in a non-erasable manner.

The reference template stored in the memory 25 is referred to in calculating a distance from the projection optical system 11 to each portion of an object to be detected.

For instance, in the case where an object is located at a position nearer to the distance Ls shown in FIG. 4A, DP light (DPn) corresponding to a segment area Sn on the reference pattern is reflected on the object, and is entered to an area Sn′ different from the segment area Sn. Since the projection optical system 11 and the light receiving optical system 12 are adjacent to each other in X-axis direction, the displacement direction of the area Sn′ relative to the segment area Sn is aligned in parallel to X-axis. In the case shown in FIG. 4A, since the object is located at a position nearer to the distance Ls, the area Sn′ is displaced relative to the segment area Sn in plus X-axis direction. If the object is located at a position farther from the distance Ls, the area Sn′ is displaced relative to the segment area Sn in minus X-axis direction.

A distance Lr from the projection optical system 11 to a portion of the object irradiated with DP light (DPn) is calculated, using the distance Ls, and based on a displacement direction and a displacement amount of the area Sn′ relative to the segment area Sn, by a triangulation method. A distance from the projection optical system 11 to a portion of the object corresponding to the other segment area is calculated in the same manner as described above.

In performing the distance calculation, it is necessary to detect to which position, a segment area Sn of the reference template has displaced at the time of actual measurement. The detection is performed by performing a matching operation between a dot pattern of DP light irradiated onto the CMOS image sensor 124 at the time of actual measurement, and a dot pattern included in the segment area Sn.

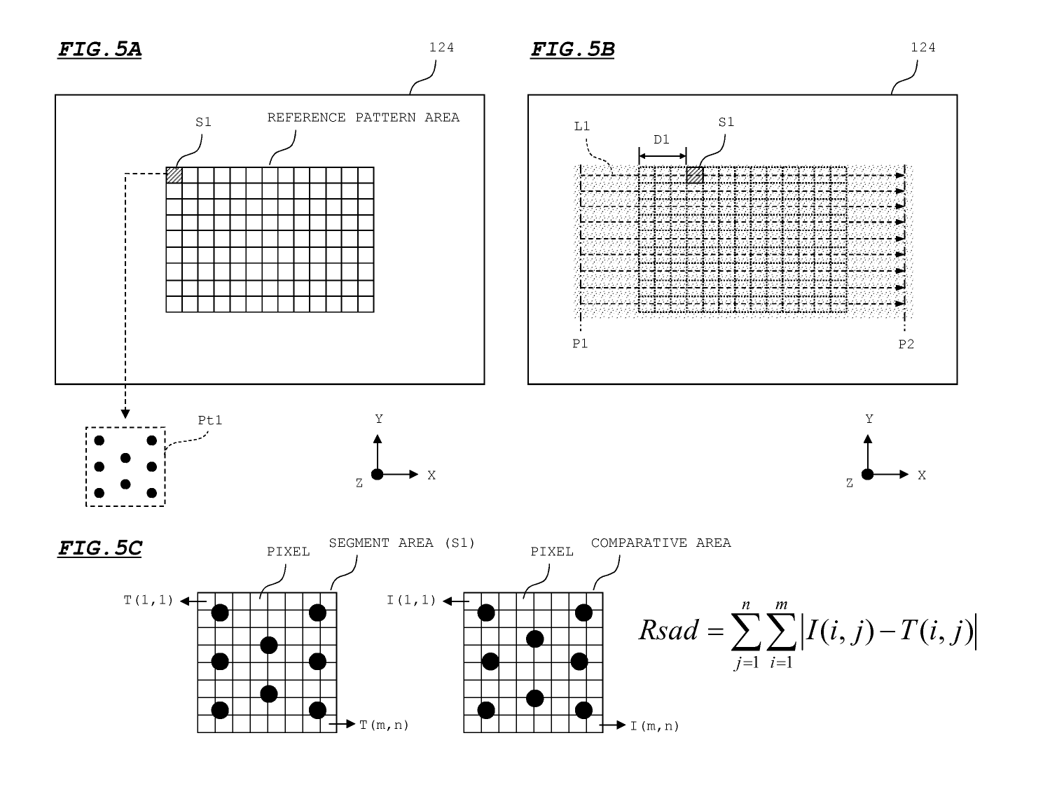

FIGS. 5A through 5C are diagrams for describing the aforementioned detection method. FIG. 5A is a diagram showing a state as to how a reference pattern area and a segment area are set on the CMOS image sensor 124, FIG. 5B is a diagram showing a segment area searching method to be performed at the time of actual measurement, and FIG. 5C is a diagram showing a matching method between an actually measured dot pattern of DP light, and a dot pattern included in a segment area of a reference template.

For instance, in the case where a displacement position of a segment area S1 at the time of actual measurement shown in FIG. 5A is searched, as shown in FIG. 5B, the segment area S1 is fed pixel by pixel in X-axis direction in a range from P1 to P2 for obtaining a matching degree between the dot pattern of the segment area S1, and the actually measured dot pattern of DP light, at each feeding position. In this case, the segment area S1 is fed in X-axis direction only on a line L1 passing an uppermost segment area group in the reference pattern area. This is because, as described above, each segment area is normally displaced only in X-axis direction from a position set by the reference template at the time of actual measurement. In other words, the segment area S1 is conceived to be on the uppermost line L1. By performing a searching operation only in X-axis direction as described above, the processing load for searching is reduced.

At the time of actual measurement, a segment area may be deviated in X-axis direction from the range of the reference pattern area, depending on the position of an object to be detected. In view of the above, the range from P1 to P2 is set wider than the X-axis directional width of the reference pattern area.

At the time of detecting the matching degree, an area (comparative area) of the same size as the segment area S1 is set on the line L1, and a degree of similarity between the comparative area and the segment area S1 is obtained. Specifically, there is obtained a difference between the pixel value of each pixel in the segment area S1, and the pixel value of a pixel, in the comparative area, corresponding to the pixel in the segment area S1. Then, a value Rsad which is obtained by summing up the difference with respect to all the pixels in the comparative area is acquired as a value representing the degree of similarity.

For instance, as shown in FIG. 5C, in the case where pixels of m columns by n rows are included in one segment area, there is obtained a difference between a pixel value T (i, j) of a pixel at i-th column, j-th row in the segment area, and a pixel value I (i, j) of a pixel at i-th column, j-th row in the comparative area. Then, a difference is obtained with respect to all the pixels in the segment area, and the value Rsad is obtained by summing up the differences. In other words, the value Rsad is calculated by the following formula.

$$Rsad = {\sum }_{j = 1}^{n} {\sum }_{i = 1}^{m} \vert I ( i , j ) - T ( i , j ) \vert$$

As the value Rsad is smaller, the degree of similarity between the segment area and the comparative area is high.

At the time of a searching operation, the comparative area is sequentially set in a state that the comparative area is displaced pixel by pixel on the line L1. Then, the value Rsad is obtained for all the comparative areas on the line L1. A value Rsad smaller than a threshold value is extracted from among the obtained values Rsad. In the case where there is no value Rsad smaller than the threshold value, it is determined that the searching operation of the segment area S1 has failed. In this case, a comparative area having a smallest value among the extracted values Rsad is determined to be the area to which the segment area S1 has moved. The segment areas other than the segment area S1 on the line L1 are searched in the same manner as described above. Likewise, segment areas on the other lines are searched in the same manner as described above by setting a comparative area on the other line.

In the case where the displacement position of each segment area is searched from the dot pattern of DP light acquired at the time of actual measurement in the aforementioned manner, as described above, the distance to a portion of the object to be detected corresponding to each segment area is obtained based on the displacement positions, using a triangulation method.

The dot pattern of DP light may vary depending on e.g. the shape or the position of the DOE 114, and the wavelength of laser light to be emitted from the laser light source 111. However, these factors are likely to change depending on a temperature, and may change as time elapses. In particular, in the case where the DOE 114 is made of a resin material, the characteristic of the DOE 114 is likely to change depending on a temperature, and the dot pattern is also likely to change, as the characteristic of the DOE 114 changes. If the dot pattern changes as described above, the dot pattern retained as the reference template is no longer appropriate, and it is impossible to accurately perform a matching operation between the dot pattern at the time of actual measurement, and the dot pattern retained on the reference template. As a result, detection precision of a distance to the object to be detected may be lowered.

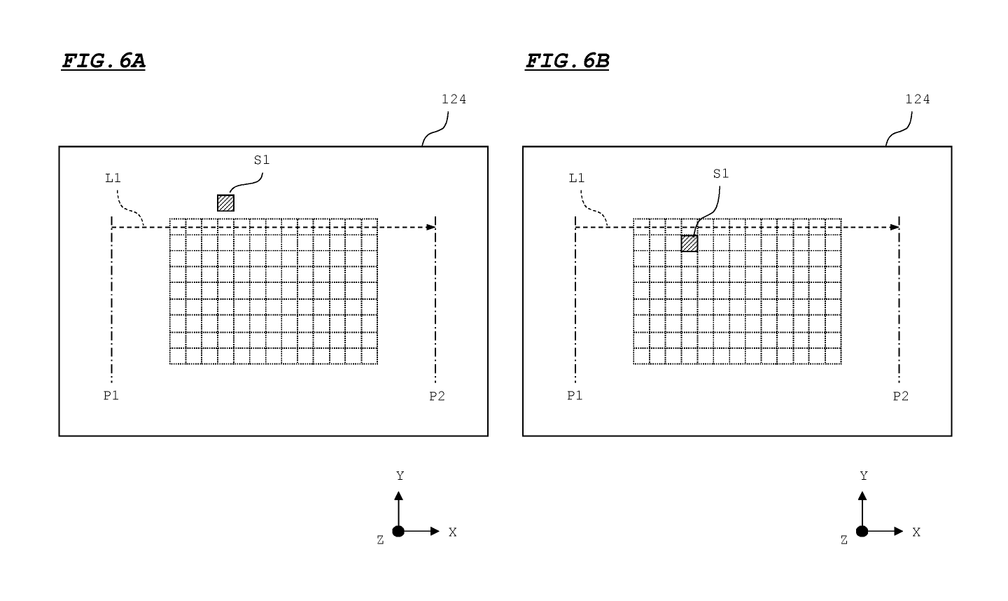

FIGS. 6A, 6B are diagrams showing a state that the segment area S1 at the time of actual measurement is deviated from the line L1 resulting from the aforementioned factors. In FIG. 6A, the segment area S1 is deviated to an upper side (plus Y-axis direction) of the line L1, and in FIG. 6B, the segment area S1 is deviated to a lower side (minus Y-axis direction) of the line L1. In both of the cases, even if a searching operation is performed on the line L1 as described above, it is impossible to extract a displacement area of the segment area S1. Therefore, the searching operation of the segment area S1 results in a failure, which may degrade the detection precision of a distance to an object to be detected.

In this embodiment, an updated template with respect to a reference template is generated based on a dot pattern of DP light at the time of actual measurement, and a segment area searching operation is performed using the updated template for eliminating the aforementioned drawback.

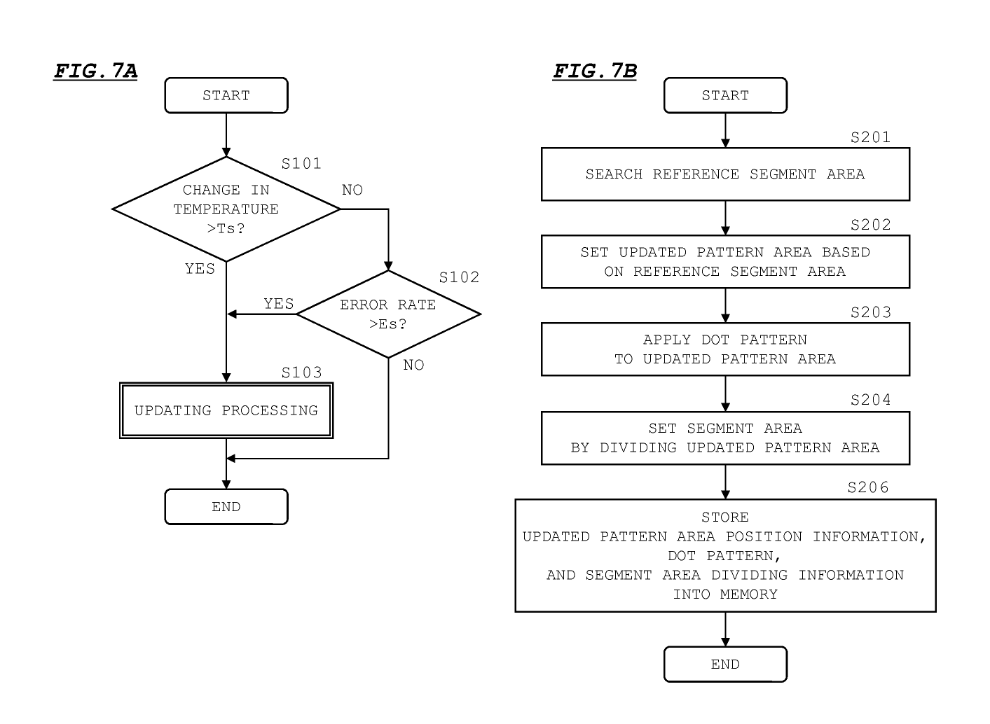

FIGS. 7A, 7B are diagrams showing a processing to be performed when a template is updated. The processing shown in FIGS. 7A, 7B is performed by an updating section 21b shown in FIG. 2. The updating section 21b performs the processing shown in FIG. 7A at a predetermined time interval at the time of actual measurement.

Referring to FIG. 7A, the updating section 21b determines whether a difference between a temperature (previous temperature) acquired by the temperature sensor 115 at the time of a previous updating operation, and a temperature (current temperature) currently detected by the temperature sensor 115 has exceeded a threshold value Ts (S101). At the time of activation of the information acquiring device 1, it is determined whether a difference between a reference temperature at the time of configuring a reference template, and a current temperature has exceeded the threshold value Ts.

If the determination result in S101 is affirmative, an updating processing of the template is performed (S103). If the determination result in S101 is negative, it is determined whether a ratio of segment areas indicating that a searching operation has failed relative to all the segment areas has exceeded a threshold value Es in a segment area searching operation at the time of a most recent actual measurement. If the determination result in S102 is affirmative, the updating processing of the template is performed (S103), and the determination result in S102 is negative, template updating is finished.

FIG. 7B is a flowchart showing the updating processing in S103 shown in FIG. 7A. The processing shown in FIG. 7B is performed by referring to the aforementioned reference template stored in advance in the memory 25, and dot pattern information acquired at the time of actual measurement and expanded in the memory 25. As described above, the reference template includes information relating to the position of a reference pattern area, pixel values of all the pixels included in the reference pattern area, and information for use in dividing the reference pattern area into segment areas. In the following, description is made based on a dot pattern for simplifying the description.

Referring to FIG. 7B, the updating section 21b searches a displacement position of a predetermined referenced segment area from the dot pattern of DP light on the CMOS image sensor 124 at the time of actual measurement (S201).

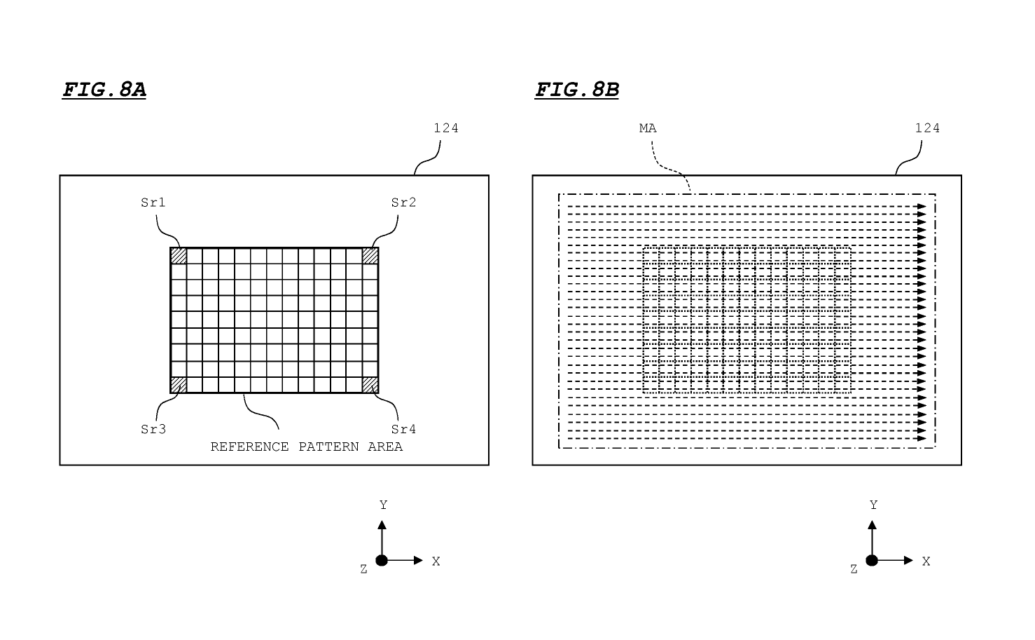

In this embodiment, as shown in FIG. 8A, referenced segment areas Sr1 through Sr4 are set at four corners of a reference pattern area of a reference template. A searching operation is performed as to which position in a searching area MA shown in FIG. 8B, these referenced segment areas Sr1 through Sr4 are located. The searching area MA covers substantially the entirety of a light receiving area of the CMOS image sensor 124. Further, the searching operation is performed by performing a matching operation for the entirety of the searching area MA, with respect to each of the referenced segment areas Sr1 through Sr4. Specifically, after a searching operation is performed for an uppermost line in the searching area MA, a searching operation is performed for a succeeding line lower than the uppermost line by one pixel, and a searching operation is successively performed for a lower line in the same manner as described above. The searching operation is performed in the same manner as described above referring to FIG. 5C.

Referring back to FIG. 7B, if the displacement positions of the referenced segment areas Sr1 through Sr4 are acquired in S201, the updating section 21b sets an area (updated pattern area) suitable for a current dot pattern on the CMOS image sensor 124, based on the acquired displacement positions (S202). In this embodiment, displacement amounts of the referenced segment areas Sr1 through Sr4 in Y-axis direction are obtained from the displacement positions of the referenced segment areas Sr1 through Sr4. Then, a rectangular area formed by connecting positions that have been displaced from the corners of the reference pattern area, by the displacement amounts of the referenced segment areas Sr1 through Sr4 in Y-axis direction, is set as an updated pattern area.

Then, the updating section 21b applies the dot pattern of the reference template to the updated pattern area thus set (S203). Further, the updating section 21b sets a segment area by dividing the updated pattern area (S204). Then, the updating section 21b causes the memory 25 to store therein, as an updated template, information relating to the position of the updated pattern area, information (pixel values of all the pixels) relating to a dot pattern included in the updated pattern area, and information for use in dividing the updated pattern area into segment areas. By dividing a mapping area on pixel values of all the pixels included in the updated pattern area into segment areas, pixel values (a dot pattern) of pixels included in each segment area is acquired.

After the updated template is configured as described above, the aforementioned segment area searching operation is performed using the updated template.

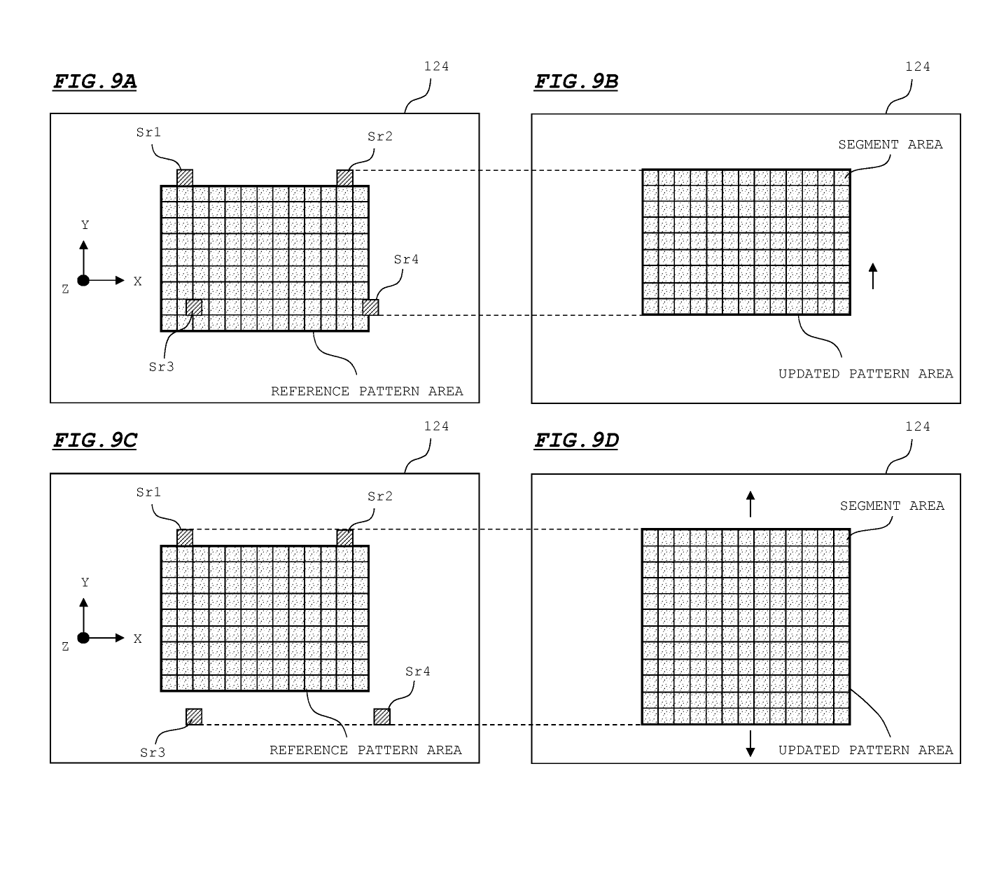

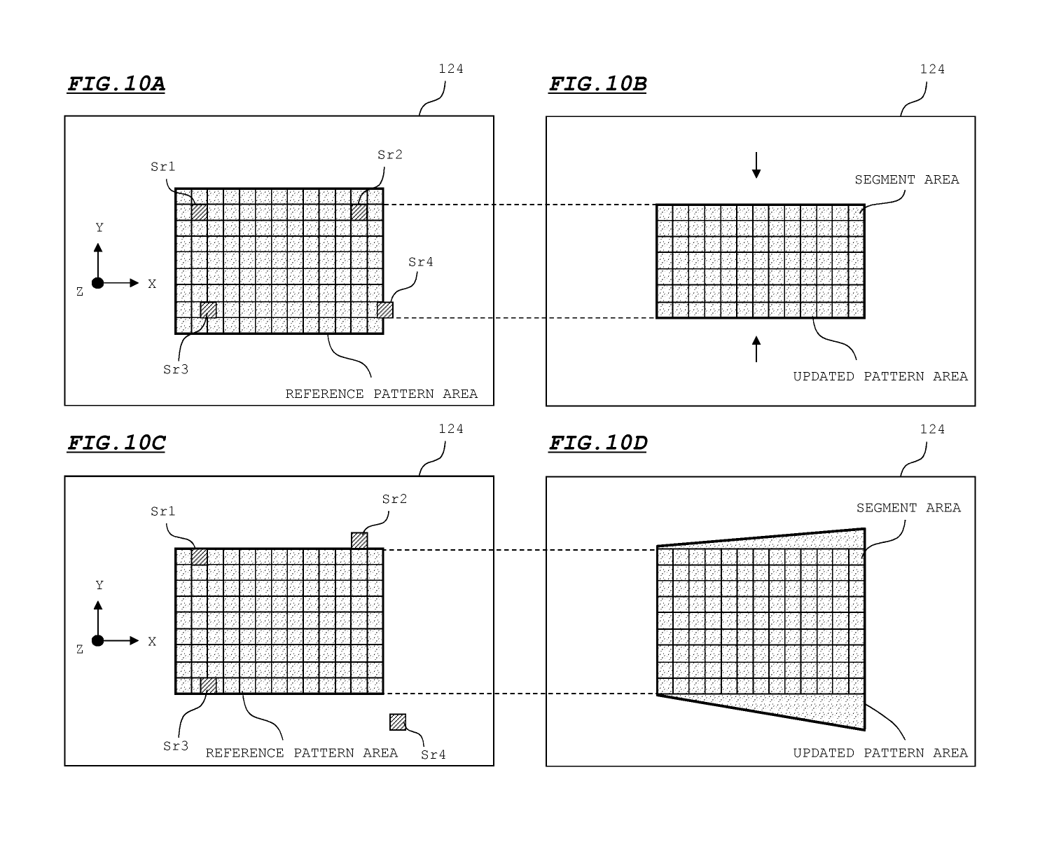

FIGS. 9A through 9D and FIGS. 10A through 10D show configuration examples of an updated template.

FIG. 9A shows a case that the positions of the referenced segment areas Sr1 through Sr4 searched in S201 shown in FIG. 7B are displaced by a certain amount in upper direction (plus Y-axis direction) with respect to a reference pattern area. In this case, as shown in FIG. 9B, a rectangular area formed by connecting positions that have been displaced from the corners of the reference pattern area, by the displacement amounts of the referenced segment areas Sr1 through Sr4 in Y-axis direction in upper direction (plus Y-axis direction), is set as an updated pattern area.

Then, the dot pattern of the reference template is applied to the updated pattern area thus set. In this case, since the reference pattern area and the updated pattern area have the same size as each other, the dot pattern in the reference pattern area is applied to the updated pattern area, as it is. Thereafter, the updated pattern area is divided into segment areas in the form of a matrix. Thus, the updated template is configured.

FIG. 9C shows a case that the positions of the referenced segment areas Sr1, Sr2 searched in S201 shown in FIG. 7B are displaced by a certain amount in upper direction (plus Y-axis direction) with respect to a reference pattern area, and the positions of the referenced segment areas Sr3, Sr4 are displaced by a certain amount in lower direction (minus Y-axis direction) with respect to the reference pattern area. In this case, as shown in FIG. 9D, a rectangular area formed by connecting positions that have been displaced from the upper two corners of the reference pattern area, by the displacement amounts of the referenced segment areas Sr1, Sr2 in upper direction (plus Y-axis direction), and positions that have been displaced from the lower two corners of the reference pattern area, by the displacement amounts of the referenced segment areas Sr3, Sr4 in Y-axis direction in lower direction (minus Y-axis direction), is set as an updated pattern area.

Then, the dot pattern of the reference template is applied to the updated pattern area thus set. In this case, since the updated pattern area has such a shape that the reference pattern area is expanded in Y-axis direction, the dot pattern in the reference pattern area is applied to the updated pattern area in such a manner that the dot pattern is uniformly expanded in Y-axis direction. Thereafter, the updated pattern area is divided into segment areas in the form of a matrix. In this embodiment, each segment area of the updated template has the same size as each segment area of the reference template. Accordingly, the number of segment areas of the updated template is larger than that of the reference template. Thus, the updated template is configured.

FIG. 10A shows a case that the positions of the referenced segment areas Sr1, Sr2 searched in S201 shown in FIG. 7B are displaced by a certain amount in lower direction (minus Y-axis direction) with respect to a reference pattern area, and the positions of the referenced segment areas Sr3, Sr4 are displaced by a certain amount in upper direction (plus Y-axis direction) with respect to the reference pattern area. In this case, as shown in FIG. 10B, a rectangular area formed by connecting positions that have been displaced from the upper two corners of the reference pattern area, by the displacement amounts of the referenced segment areas Sr1, Sr2 in Y-axis direction in lower direction (minus Y-axis direction), and positions that have been displaced from the lower two corners of the reference pattern area, by the displacement amounts of the referenced segment areas Sr3, Sr4 in Y-axis direction in upper direction (plus Y-axis direction), is set as an updated pattern area.

Then, the dot pattern of the reference template is applied to the updated pattern area thus set. In this case, since the updated pattern area has such a shape that the reference pattern area is contracted in Y-axis direction, the dot pattern in the reference pattern area is applied to the updated pattern area in such a manner that the dot pattern is uniformly contracted in Y-axis direction. Thereafter, the updated pattern area is divided into segment areas in the form of a matrix. In this embodiment, each segment area of the updated template has the same size as each segment area of the reference template. Accordingly, the number of segment areas of the updated template is smaller than that of the reference template. Thus, the updated template is configured.

FIG. 10C shows a case that the position of the referenced segment area Sr2 searched in S201 shown in FIG. 7B is displaced by a certain amount in upper direction (plus Y-axis direction) with respect to a reference pattern area, and the position of the referenced segment area Sr4 is displaced by a certain amount in lower direction (minus Y-axis direction) with respect to the reference pattern area. In this case, as shown in FIG. 10D, a rectangular area formed by connecting positions that have been displaced from the right two corners of the reference pattern area, by the displacement amounts of the referenced segment areas Sr2, Sr4 in Y-axis direction in upper direction (plus Y-axis direction) and in lower direction (minus Y-axis direction), and the left two corners of the reference pattern area, is set as an updated pattern area. In this case, the updated pattern area has a trapezoidal shape.

Then, the dot pattern of the reference template is applied to the updated pattern area thus set. In this case, since the updated pattern area has such a shape that the reference pattern area is expanded in Y-axis direction, the dot pattern in the reference pattern area is applied to the updated pattern area in such a manner that the dot pattern is expanded in Y-axis direction in accordance with a displacement of the updated pattern area in Y-axis direction. Thereafter, the updated pattern area is divided into segment areas in the form of a matrix.

In this embodiment, a maximum rectangular area is set within an updated pattern area, and the maximum rectangular area is divided into segment areas in the form of a matrix. Thus, the updated template is configured.

In FIGS. 10C, 10D, a maximum rectangular area set in an updated pattern area has the same size as a reference pattern area. Further, the position of the updated pattern area and the position of the reference pattern area are the same as each other. Further, in this embodiment, since the size of each segment area of an updated template is the same as that of each segment area of a reference template, the number of segment areas of the updated template is the same as the number of segment areas of the reference template. However, the updated template has a dot pattern which is expanded into a trapezoidal shape with respect to the dot pattern in the reference pattern area. Accordingly, the dot pattern of each segment area of the updated template differs from the dot pattern of a segment area of the reference template, which corresponds to the area of the updated template.

FIGS. 10C, 10D show an example, in which an updated pattern area has a trapezoidal shape. Alternatively, in the case where an updated pattern area has a trapezoidal shape other than the shape shown in FIG. 10D, an updated template is configured by applying the dot pattern of a reference template to the updated pattern area, setting a maximum rectangular area within the updated pattern area, and dividing the maximum rectangular area into segment areas in the form of a matrix in the same manner as described above.

As described above, according to the embodiment, a reference template is updated, based on a displacement of a referenced segment area set in the reference template at the time of actual measurement, and a segment area searching operation is performed, using a template (an updated template) after an updating operation has been performed. Accordingly, even if a dot pattern of laser light varies depending on e.g. the shape or the position of the DOE 114, and the wavelength of laser light, a segment area searching operation can be performed accurately. Thus, it is possible to accurately detect a distance to an object to be detected.

Further, according to the embodiment, as shown in FIG. 7A, in the case where a dot pattern of laser light is likely to change e.g. in the case where a temperature change is large or an error rate of a segment area searching operation is large, a reference template updating processing is performed. Thus, the reference template updating can be effectively performed.

The embodiment of the invention has been described as above. The invention is not limited to the foregoing embodiment, and the embodiment of the invention may be changed or modified in various ways other than the above.

For instance, in the embodiment, an updated pattern area is configured by shifting/deforming a reference pattern area only in up and down directions (Y-axis direction). This is because a segment area searching operation can be performed by an updated template, without deforming a reference pattern area in X-axis direction. Specifically, in the updated template in this embodiment, the position of a segment area may be deviated from a proper position in X-axis direction. However, since the deviation is deviation in X-axis direction, it is possible to acquire a displacement position of a segment area at the time of actual measurement without failure by performing a segment area searching operation in X-axis direction as described above. In this case, the acquired displacement position may be deviated from the position to be detected, and normally, such a deviation is negligibly small. Thus, distance information can be acquired in a satisfactory manner.

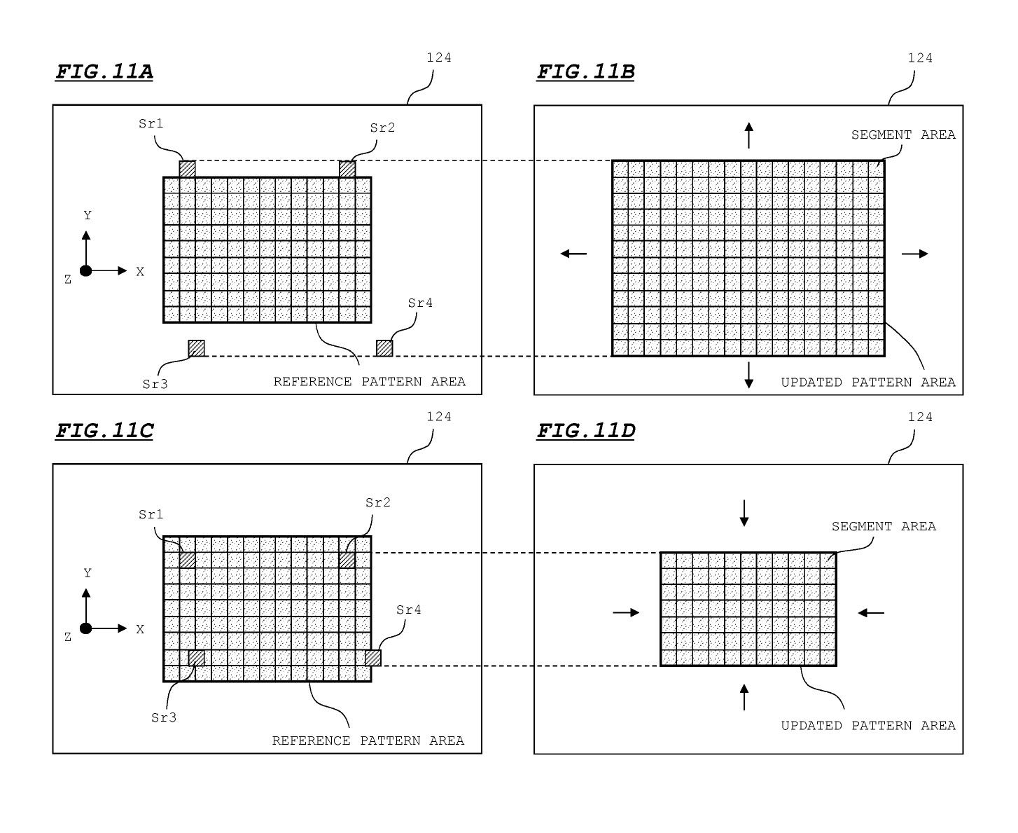

However, in the case where deviation in X-axis direction regarding the displacement position of a segment area also intended to be eliminated as well as in Y-axis direction, an updated pattern area may be configured by deforming a reference pattern area in X-axis direction as well as in Y-axis direction, as shown in FIGS. 11A through 11D. FIGS. 11A, 11B show an example, in which an updated pattern area is configured by expanding a reference pattern area in X-axis direction, as well as in Y-axis direction; and FIGS. 11C, 11D show an example, in which an updated pattern area is configured by contracting a reference pattern area in X-axis direction, as well as in Y-axis direction.

In the modification, a method for expanding/contracting a reference pattern area in X-axis direction with the same ratio as in Y-axis direction may be performed. Alternatively, an updated pattern area may be configured by expanding/contracting a reference pattern area in X-axis direction, based on a temperature detected at the time of actual measurement. In the modification, a temperature and a ratio of expansion/contraction in X-axis direction are stored in the memory 25 in correlation to each other. The adjustment based on a temperature may also be applied to a case where an updated pattern area is not expanded/contracted in Y-axis direction with respect to a reference pattern area.

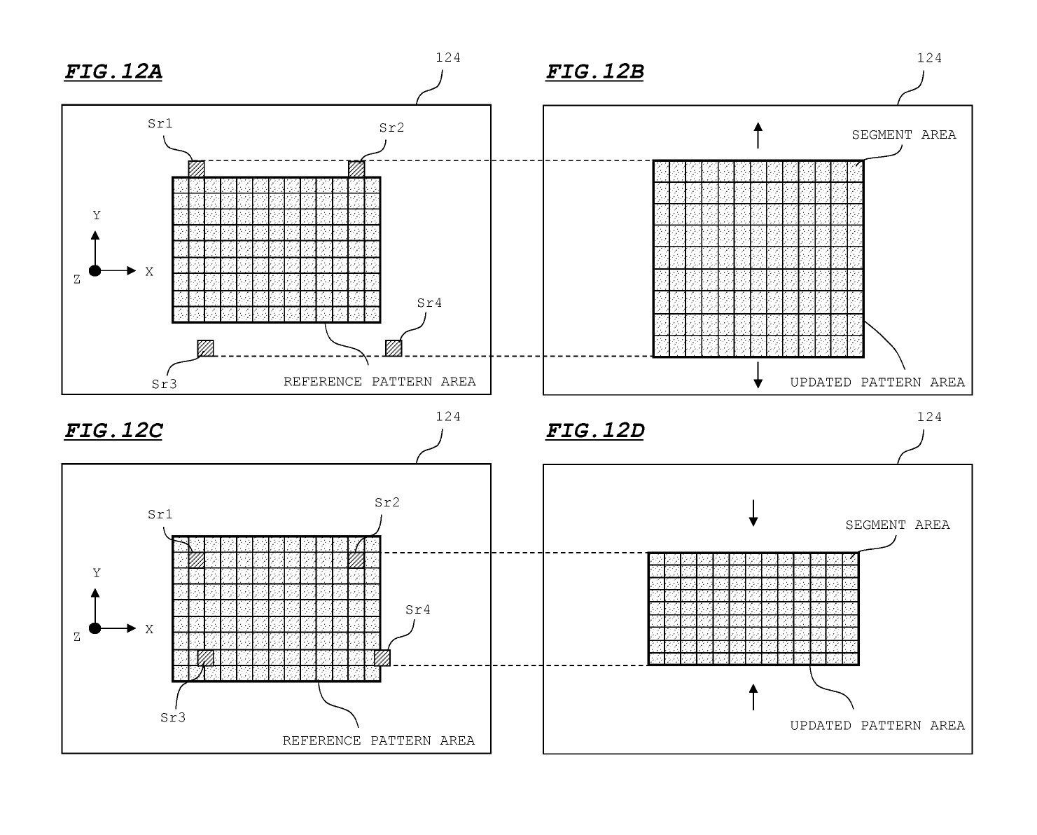

Further, in the embodiment, the size of a segment area of an updated template is equal to the size of a segment area of a reference template, even in the case where the updated pattern area is expanded/contracted with respect to the reference pattern area. Alternatively, as shown in FIGS. 12A through 12D, the number of segment areas of an updated template may be equal to the number of segments areas of a reference template, in place of the above. FIGS. 12A, 12B show an example, in which an updated pattern area is configured by expanding a reference pattern area in Y-axis direction, and FIGS. 12C, 12D show an example, in which an updated pattern area is configured by contracting a reference pattern area in Y-axis direction. In the above arrangement, the segment area of the updated template has such a shape that the segment area of the reference template is expanded/contracted in Y-axis direction.

Further, in the embodiment, a part of segment areas of a reference template is used as the referenced segment areas Sr1 through Sr4. Alternatively, an area other than the segment areas of the reference template may be set as a referenced segment area.

Further, in the embodiment, the referenced segment areas Sr1 through Sr4 are set at four corners of a reference pattern area. Alternatively, the referenced segment areas may be set at two areas away from each other in Y-axis direction, and at other two areas that are located away from each other in Y-axis direction and do not overlap the two areas in Y-axis direction, in addition to the aforementioned arrangement that the referenced segment areas are set at four corners. This enables to configure an updated pattern area not only by shifting a reference pattern area in Y-axis direction, but also by deforming the reference pattern area in Y-axis direction in the same manner as in the embodiment.

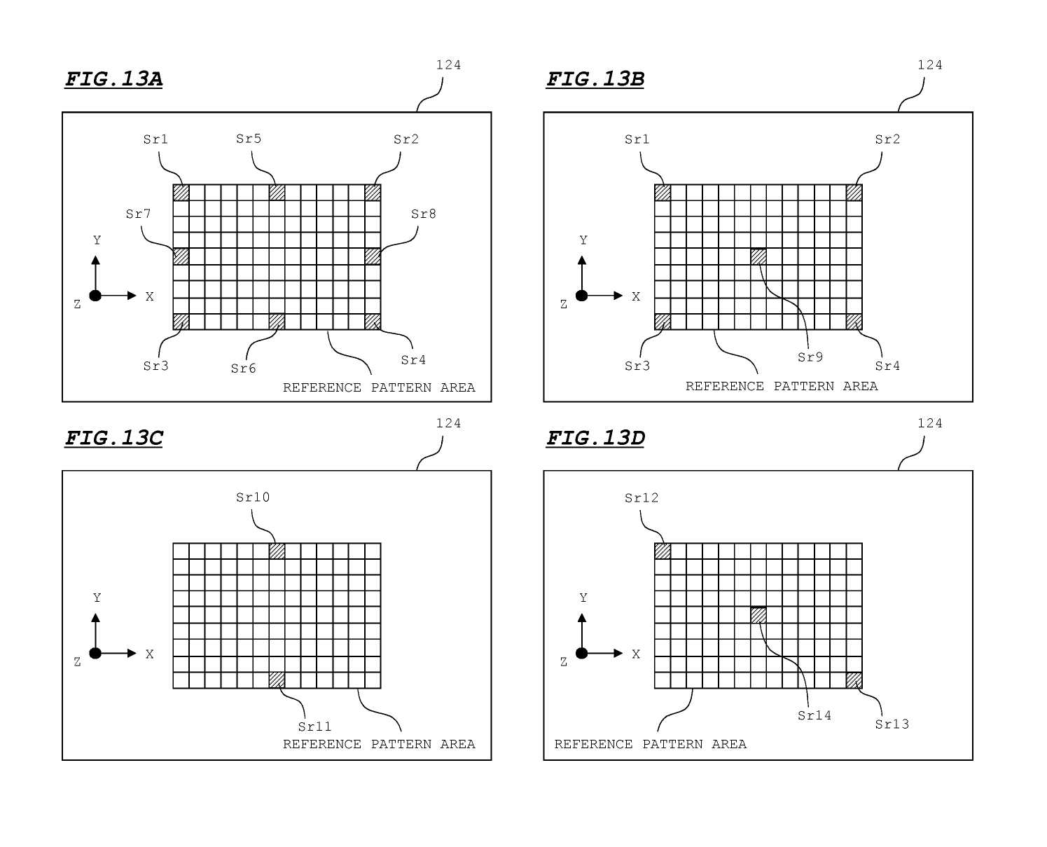

Further alternatively, as shown in FIG. 13A, referenced segment areas Sr5 through Sr8 may be added to side portions of the reference pattern area for increasing the number of referenced segment areas to be set. The modification enables to set the updated pattern area by more finely deforming the reference pattern area. Further alternatively, as shown in FIG. 13B, a referenced segment area Sr9 may be additionally set at the center of the reference pattern area. The modification enables to set the updated pattern area by using a displacement position of the referenced segment area Sr9 as the centroid.

Further alternatively, as shown in FIG. 13C, only two referenced segment areas Sr10, Sr11 may be set at an upper position and at a lower position. Although the modification enables to configure an updated pattern area by shifting, expanding/contracting a reference pattern area in Y-axis direction, it is impossible to configure an updated pattern area by deforming a reference pattern area into a trapezoidal shape, unlike the arrangement shown in FIGS. 10C, 10D.

Further alternatively, as shown in FIG. 13D, three referenced segment areas Sr12, Sr13, Sr14 may be set at two diagonal corners and at the center of a reference pattern area. In the modification, it is also impossible to configure an updated pattern area by deforming a reference pattern area into a trapezoidal shape, unlike the arrangement shown in FIGS. 10C, 10D. However, it is possible to set an updated pattern area by using a displacement position of the referenced segment area Sr14 as the centroid.

Further, in the embodiment, segment areas are set without overlapping each other, as shown in FIG. 4B. Alternatively, segment areas may be set in such a manner that upper and lower segment areas partially overlap each other. Further alternatively, segment areas may be set in such a manner that left and right segment areas partially overlap each other in the form of a matrix. The reference template in the modification may include information relating to the position of a reference pattern area on the CMOS image sensor 124, pixel values of all the pixels included in the reference pattern area, information relating to the size (the length and the breadth) of a segment area, and information relating to the position of each segment area in the reference pattern area.

Further alternatively, the shape of the reference pattern area may be a square shape or other shape, in addition to the rectangular shape as described in the embodiment. Further alternatively, the shape of the updated pattern area may be modified, as necessary.

In the embodiment, the CMOS image sensor 124 is used as a light receiving element. Alternatively, a CCD image sensor may be used.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a light source which emits light of a predetermined wavelength band;
a projection optical system which projects the light emitted from the light source toward the target area with a predetermined dot pattern;
a light receiving element which receives reflected light reflected on the target area for outputting a signal;
a storage which stores a reference template in which a plurality of reference segment areas are set on a reference pattern of the light to be received by the light receiving element; and
an updating section which updates the reference template, wherein
the updating section updates the reference template, based on a displacement of a referenced segment area set in the reference template at the time of actual measurement.

2. The information acquiring device according to claim 1, wherein
the updating section configures an updated template by:
performing a matching operation between the reference pattern, and an actual measurement pattern of the light received by the light receiving element at the time of actual measurement,
setting an updated pattern area from a position, on the actual measurement pattern, of the referenced segment area set on the reference pattern,
applying the reference pattern to the set updated pattern area for setting an updated pattern, and
setting a plurality of updated segment areas in the set updated pattern.

3. The information acquiring device according to claim 2, wherein
the updated pattern area is set by shifting or deforming, in a direction perpendicular to an alignment direction in which the light source and the light receiving element are aligned, a reference pattern area having the reference pattern, based on a displacement amount of the referenced segment area on the light receiving element in the perpendicular direction.

4. The information acquiring device according to claim 3, wherein
the referenced segment area is set at two areas away from each other in the perpendicular direction, and at other two areas that are located away from each other in the perpendicular direction and do not overlap the two areas in the perpendicular direction.

5. The information acquiring device according to claim 1, further comprising:
a temperature sensor which detects a temperature in the information acquiring device, wherein
the updating section updates the reference template, in the case where a change in the temperature detected by the temperature sensor exceeds a predetermined threshold value.

6. An object detecting device, comprising:
an information acquiring device which acquires information on a target area using light,
the information acquiring device including:
a light source which emits light of a predetermined wavelength band;
a projection optical system which projects the light emitted from the light source toward the target area with a predetermined dot pattern;
a light receiving element which receives reflected light reflected on the target area for outputting a signal;
a storage which stores a reference template in which a plurality of reference segment areas are set on a reference pattern of the light to be received by the light receiving element; and
an updating section which updates the reference template, wherein
the updating section updates the reference template, based on a displacement of a referenced segment area set in the reference template at the time of actual measurement.

7. The object detecting device according to claim 6, wherein
the updating section configures an updated template by:
performing a matching operation between the reference pattern, and an actual measurement pattern of the light received by the light receiving element at the time of actual measurement,
setting an updated pattern area from a position, on the actual measurement pattern, of the referenced segment area set on the reference pattern,
applying the reference pattern to the set updated pattern area for setting an updated pattern, and
setting a plurality of updated segment areas in the set updated pattern.

8. The object detecting device according to claim 7, wherein
the updated pattern area is set by shifting or deforming, in a direction perpendicular to an alignment direction in which the light source and the light receiving element are aligned, a reference pattern area having the reference pattern, based on a displacement amount of the referenced segment area on the light receiving element in the perpendicular direction.

9. The object detecting device according to claim 8, wherein
the referenced segment area is set at two areas away from each other in the perpendicular direction, and at other two areas that are located away from each other in the perpendicular direction and do not overlap the two areas in the perpendicular direction.

10. The object detecting device according to claim 6, wherein:
the information acquiring device further includes a temperature sensor which detects a temperature in the information acquiring device, and
the updating section updates the reference template, in the case where a change in the temperature detected by the temperature sensor exceeds a predetermined threshold value.
